(19) United States
(12) Patent Application Publication
(10) Pub. No.: US 2024/0143006 A1
(43) Pub. Date: May 2, 2024

(54) ADAPTIVE OVERSHOOT-VOLTAGE SUPPRESSION CIRCUIT, REFERENCE CIRCUIT, CHIP AND COMMUNICATION TERMINAL

(71) Applicant: VANCHIP (TIANJIN) TECHNOLOGY CO., LTD., Tianjin (CN)

(72) Inventors: Yongshou WANG, Tianjin (CN); Cheng CHEN, Tianjin (CN); Chunling LI, Tianjin (CN); Chenyang GAO, Tianjin (CN)

(73) Assignee: VANCHIP (TIANJIN) TECHNOLOGY CO., LTD., Tianjin, TJ (CN)

(21) Appl. No.: 18/408,534

(22) Filed: Jan. 9, 2024

Related U.S. Application Data
(63) Continuation of application No. PCT/CN2022/106888, filed on Jul. 20, 2022.

(30) Foreign Application Priority Data
Jul. 29, 2021 (CN) 202110862110.9

(51) Int. Cl. G05F 1/571; G05F 1/46; G05F 3/26

(52) U.S. Cl. CPC G05F 1/571; G05F 1/468; G05F 3/262

(57) ABSTRACT

An adaptive overshoot-voltage suppression circuit (100), a reference circuit, a chip and a communication terminal. The adaptive overshoot-voltage suppression circuit (100) comprises an overshoot-voltage suppression unit (1001) and a voltage-current conversion unit (1002), wherein an input end of the overshoot-voltage suppression unit (1001) is connected to a preset sampling point on a reference circuit to be tested, an output end of the overshoot-voltage suppression unit (1001) is connected to an input end of the voltage-current conversion unit (1002), and an output end of the voltage-current conversion unit (1002) is connected to a preset adjustment point on said reference circuit.

### BACKGROUND

### Technical Field

The present invention relates to an adaptive overshoot-voltage suppression circuit, and to a reference circuit including the adaptive overshoot-voltage suppression circuit, an integrated circuit chip, and a corresponding communication terminal, and relates to the field of integrated circuit technologies.

### Related Art

With continuous advancement of integrated circuit process as well as popularization and development of 5G technologies, a requirement for timing response of devices in a 5G system is getting higher. This poses a challenge to response time of circuit modules inside the devices. Especially, in a power amplifier (PA) system, not only does a strict requirement on response time need to be met, but a large overshoot needs to be prevented in a supply voltage provided for the PA system.

Usually, in a circuit system, the system generates a large overshoot-voltage or current to achieve fast system response. However, in a PA system, a large overshoot in a supply voltage or current provided for the PA system can cause serious impact on the life and performance of the PA system. It is widely known that the PA system is provided with a supply voltage by a low dropout regulator circuit, and a reference voltage needed by the circuit is provided by a reference circuit. Therefore, designing a reference circuit that can respond quickly and has a small overshoot is of great significance for the low dropout regulator circuit to provide a stable supply voltage for the PA system.

### SUMMARY

A primary technical problem to be solved by the present invention is to provide an adaptive overshoot-voltage suppression circuit.

Another technical problem to be solved by the present invention is to provide a reference circuit including an adaptive overshoot-voltage suppression circuit, a chip, and a communication terminal.

To achieve the above objectives, the following technical solutions are used in the present invention.

According to a first aspect of embodiments of the present invention, an adaptive overshoot-voltage suppression circuit is provided. The adaptive overshoot-voltage suppression circuit includes an overshoot-voltage suppression unit and a voltage-to-current conversion unit. An input end of the overshoot-voltage suppression unit is connected to a preset sampling point on a to-be-measured reference circuit. An output end of the overshoot-voltage suppression unit is connected to an input end of the voltage-to-current conversion unit. An output end of the voltage-to-current conversion unit is connected to a preset regulating point on the to-be-measured reference circuit.

In a starting process of the to-be-measured reference circuit, the overshoot-voltage suppression unit generates a transient high-frequency inducted voltage based on a sampling voltage obtained from the to-be-measured reference circuit. The transient high-frequency inducted voltage is converted into a corresponding pull-up current through the voltage-to-current conversion unit. The pull-up current is injected into the to-be-measured reference circuit, and is superposed with a pull-down starting current of the to-be-measured reference circuit, to reduce a nonlinear starting current at a starting moment of the to-be-measured reference circuit.

Preferentially, the overshoot-voltage suppression unit includes a capacitor, a first NMOS transistor, and a second NMOS transistor, an end of the capacitor is connected to the sampling point and a gate of the first NMOS transistor, the other end of the capacitor is connected to a drain of the first NMOS transistor and a drain of the second NMOS transistor, a gate of the second NMOS transistor is connected to an external enable circuit, and a source of the first NMOS transistor and a source of the second NMOS transistor are connected to a common ground end voltage.

Preferentially, the voltage-to-current conversion unit includes a third NMOS transistor, a first resistor, a first PMOS transistor, and a second PMOS transistor, a gate of the third NMOS transistor is connected to the drain of the first NMOS transistor, the drain of the second NMOS transistor, and the other end of the capacitor, a source of the third NMOS transistor is connected to an end of the first resistor, a drain of the third NMOS transistor is connected to a drain and gate of the first PMOS transistor and a gate of the second PMOS transistor, a drain of the second PMOS transistor is connected to the regulating point, a source of the first PMOS transistor and a source of the second PMOS transistor are connected to a power supply voltage, and the other end of the first resistor is connected to the common ground end voltage.

According to a second aspect of embodiments of the present invention, a reference circuit is provided. The reference circuit includes a starting module, a reference core module, and the foregoing adaptive overshoot-voltage suppression circuit. An input end of the adaptive overshoot-voltage suppression circuit is connected to a preset sampling point on the reference core module. An output end of the adaptive overshoot-voltage suppression circuit is connected to a preset regulating point on the starting module.

Preferentially, the regulating point is a position where the starting module outputs a starting current to the reference core module.

Preferentially, the sampling point is a position where the gate of the first NMOS transistor is turned on by a sampling voltage sampled from the reference core module.

According to a third aspect of embodiments of the present invention, an integrated circuit chip is provided. The integrated circuit chip includes the foregoing reference circuit.

According to a fourth aspect of embodiments of the present invention, a communication terminal is provided. The communication terminal includes the foregoing reference circuit.

According to the adaptive overshoot-voltage suppression circuit, the reference circuit, the chip, and the communication terminal provided in the present invention, in a starting process of a to-be-measured reference circuit, a transient high-frequency inducted voltage is generated based on a sampling voltage outputted by the to-be-measured reference circuit and measured in real time, and is converted into a corresponding pull-up current. The pull-up current is injected into the to-be-measured reference circuit, and is superposed with a pull-down starting current of the to-be-measured reference circuit, to reduce a nonlinear starting current at a starting moment of the to-be-measured reference circuit, so as to quickly response to and effectively suppress the overshoot of a reference voltage outputted by the reference circuit while ensuring to a certain extent that the reference circuit meets a timing requirement.

### BRIEF DESCRIPTION OF THE DRAWINGS

FIG. 1 is a schematic diagram of an adaptive overshoot-voltage suppression circuit according to an embodiment of the present invention;

FIG. 2 is a schematic block diagram of a reference circuit according to an embodiment of the present invention;

FIG. 3 is a schematic diagram of circuits of a starting module and a reference core module in a reference circuit according to an embodiment of the present invention;

FIG. 4 is a curve chart showing the change of a current according to an embodiment of the present invention; and

FIG. 5 is a diagram showing a simulated waveform during starting of a reference circuit according to an embodiment of the present invention.

### DETAILED DESCRIPTION

The following describes technical content of the present invention in detail with reference to accompanying drawings and specific embodiments.

In a starting process of a reference circuit, to quickly response to and effectively suppress overshoot of a reference voltage outputted by the circuit, as shown in FIG. 1, an embodiment of the present invention provides an adaptive overshoot-voltage suppression circuit 100, including at least an overshoot-voltage suppression unit 1001 and a voltage-to-current conversion unit 1002. An input end of the overshoot-voltage suppression unit 1001 is connected to a preset sampling point on a to-be-measured reference circuit. An output end of the overshoot-voltage suppression unit 1001 is connected to an input end of the voltage-to-current conversion unit 1002. An output end of the voltage-to-current conversion unit 1002 is connected to a preset regulating point on the to-be-measured reference circuit.

In a starting process of the to-be-measured reference circuit, the overshoot-voltage suppression unit 1001 generates a transient high-frequency inducted voltage based on a sampling voltage obtained from the to-be-measured reference circuit. The transient high-frequency inducted voltage is converted into a corresponding pull-up current through the voltage-to-current conversion unit 1002. The pull-up current is injected into the to-be-measured reference circuit, and is superposed with a pull-down starting current of the to-be-measured reference circuit, to reduce a nonlinear starting current at a starting moment of the to-be-measured reference circuit, thereby suppressing overshoot of the reference voltage outputted by the to-be-measured reference circuit.

As shown in FIG. 1, the overshoot-voltage suppression unit 1001 includes a capacitor C1, a first NMOS transistor MN1, and a second NMOS transistor MN2. An end of the capacitor C1 is used as the input end of the overshoot-voltage suppression unit 1001, and is configured to be connected to the preset sampling point on the to-be-measured reference circuit and a gate of the first NMOS transistor MN1. The other end of the capacitor C1 is connected to a drain of the first NMOS transistor MN1 and a drain of the second NMOS transistor MN2. A gate of the second NMOS transistor MN2 is connected to an external enable circuit. A source of the first NMOS transistor MN1 and a source of the second NMOS transistor MN2 are connected to a common ground end voltage VSS.

As shown in FIG. 1, the voltage-to-current conversion unit 1002 includes a third NMOS transistor MN3, a first resistor R1, a first PMOS transistor MP1, and a second PMOS transistor MP2. A gate of the third NMOS transistor MN3 is connected to the drain of the first NMOS transistor MN1, the drain of the second NMOS transistor MN2, and the other end of the capacitor C1. A source of the third NMOS transistor MN3 is connected to an end of the first resistor R1. A drain of the third NMOS transistor MN3 is connected to a drain and gate of the first PMOS transistor MP1 and a gate of the second PMOS transistor MP2. A drain of the second PMOS transistor MP2 is used as an output end of the overshoot voltage suppression unit 1001 and is connected to the preset regulating point on the to-be-measured reference circuit. A source of the first PMOS transistor MP1 and a source of the second PMOS transistor MP2 are connected to a power supply voltage VDD. The other end of the first resistor R1 is connected to the common ground end voltage VSS.

Because the adaptive overshoot-voltage suppression circuit 100 provided in embodiments of the present invention is mainly used in a reference circuit, the following describes the working principle of the adaptive overshoot-voltage suppression circuit 100 in details with respect to a reference circuit having the adaptive overshoot-voltage suppression circuit 100.

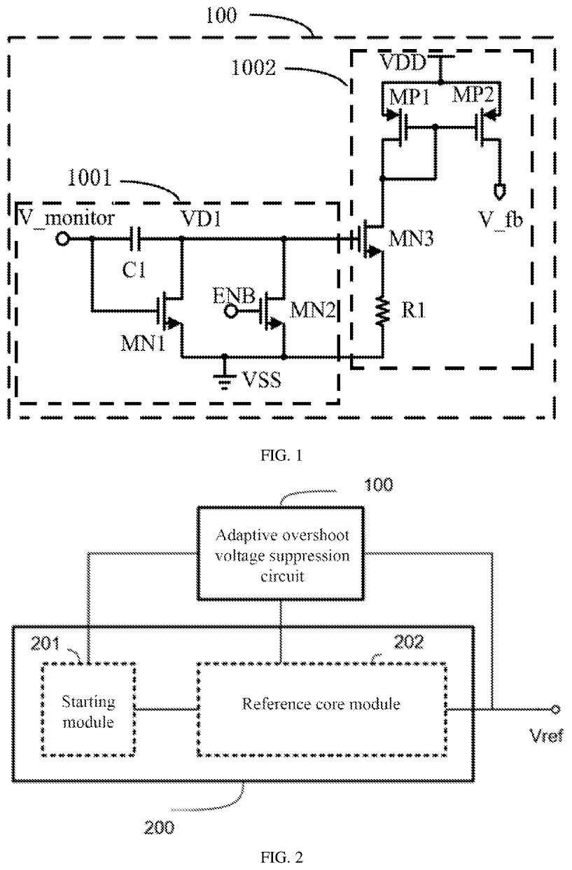

As shown in FIG. 2, a reference circuit includes an adaptive overshoot-voltage suppression circuit 100, a starting module 201, and a reference core module 202. An input end of the adaptive overshoot-voltage suppression circuit 100 is connected to a preset sampling point on the reference core module 202. An output end of the adaptive overshoot-voltage suppression circuit 100 is connected to a preset regulating point on the starting module 201.

In the present invention, the preset regulating point on the reference circuit is a position where the starting module 201 outputs a starting current to the reference core module 202. The preset sampling point on the reference circuit is a position where the gate of the first NMOS transistor MN1 may be turned on by a sampling voltage sampled from the reference core module 202.

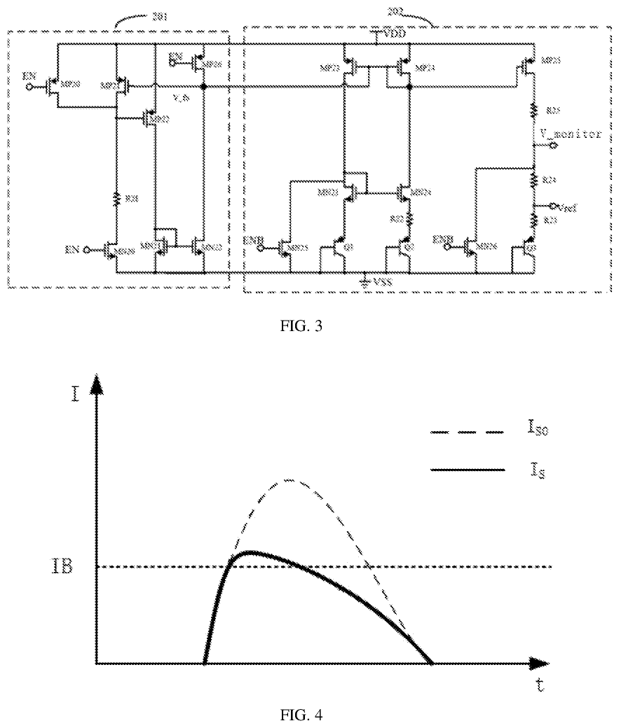

As shown in FIG. 3, the starting module 201 includes a third PMOS transistor MP20, a fourth PMOS transistor MP21, a fifth PMOS transistor MP22, a sixth PMOS transistor MP26, a fourth NMOS transistor MN20, a fifth NMOS transistor MN21, a sixth NMOS transistor MN22, and a second resistor R21. The reference core module 202 includes a first triode Q1, a second triode Q2, a third triode Q3, a seventh PMOS transistor MP23, an eighth PMOS transistor MP24, a ninth PMOS transistor MP25, a seventh NMOS transistor MN23, an eighth NMOS transistor MN24, a ninth NMOS transistor MN25, a tenth NMOS transistor MN26, a third resistor R22, a fourth resistor R23, a fifth resistor R24, and a sixth resistor R25. Circuit structures of the starting module 201 and the reference core module 202 are conventional mature technologies. Connection relationships therebetween is not described again.

The starting module 201 is configured to provide a current when a system is turned on or enabled, so that the reference core module 202 can quickly switch from an initial state to and work in a designed working state. The reference core module 202 is configured to generate a reference voltage (also referred to as a voltage reference) required by the system.

The working principle of the reference circuit to which the adaptive overshoot-voltage suppression circuit 100 is added is as follows.

When an enable EN is the ground voltage VSS, an enable ENB is the power supply voltage VDD. In this case, in the starting module 201, the third PMOS transistor MP20 and the sixth PMOS transistor MP26 are in an ON state, and the fourth NMOS transistor MN20 is in an OFF state, so that the current flowing through the second resistor R21 is increased, and a gate voltage of the fifth PMOS transistor MP22 is added to the power supply voltage VDD, so as to turn off a branch where the fifth PMOS transistor MP22 is located. Because the fifth NMOS transistor MN21 and the sixth NMOS transistor MN22 form a proportional mirror current source, the current in the fifth NMOS transistor MN21 and the current in the sixth NMOS transistor MN22 are zero. At the same time, because the fourth NMOS transistor MN20 is in an OFF state, so that the current in the branch where the fourth NMOS transistor MN20 is located is also zero. In the reference core module 202, the ninth NMOS transistor MN25 and the tenth NMOS transistor MN26 are in an ON state, and a gate voltage of the seventh NMOS transistor MN23 and a gate voltage of the eighth NMOS transistor MN24 as well as a sampling voltage V_monitor obtained from the sampling point of the reference core module 202 are all reduced to the ground voltage VSS. At the same time, a gate voltage of the seventh PMOS transistor MP23, a gate voltage of the eighth PMOS transistor MP24, and a gate voltage of the ninth PMOS transistor MP25 are increased to the power supply voltage VDD, so that branches where the seventh PMOS transistor MP23, the eighth PMOS transistor MP24, and the ninth PMOS transistor MP25 are located are turned off. In other words, the current is zero. In the adaptive overshoot-voltage suppression circuit 100, the second NMOS transistor MN2 is in an ON state, and potential of an electrode plate of the capacitor C1 connected to the second NMOS transistor MN2 is the ground voltage VSS. In this case, the sampling voltage V_monitor is also the ground voltage VSS. The first NMOS transistor MN1 and the third NMOS transistor MN3 are in a cut-off state. Because the first PMOS transistor MP1 and the second PMOS transistor MP2 form a proportional mirror current source, the current in the first PMOS transistor MP1 and the current in the second PMOS transistor MP2 are zero.

Because a PMOS transistor with a gate voltage at a low level is to be turned on, and an NMOS transistor with a gate voltage at a high level is to be turned on, an enable signal provided for the third PMOS transistor MP20, the fourth NMOS transistor MN20, the sixth PMOS transistor MP26, the ninth NMOS transistor MN25, and the tenth NMOS transistor MN26 needs to ensure that these MOS transistors are turned on or off as required in corresponding environments in the present invention.

When the enable EN jumps from the ground voltage VSS to the power supply voltage VDD, the enable ENB jumps from the power supply voltage VDD to the ground voltage VSS. At this time, the third PMOS transistor MP20, the sixth PMOS transistor MP26, the ninth NMOS transistor MN25, and the tenth NMOS transistor MN26 jump from an ON state to an OFF state, and the fourth NMOS transistor MN20 jumps from an OFF state to an ON state. Because the gate of the fifth PMOS transistor MP22 is connected to the ground voltage VSS via the second resistor R21 and the fourth NMOS transistor MN20, after the enable EN jumps from the ground voltage VSS to the power supply voltage VDD, the gate voltage of the fifth PMOS transistor MP22 is close to the ground voltage VSS, so that the fifth PMOS transistor MP22 is in an ON state. At this time, a series branch where the fifth PMOS transistor MP22 and the fifth NMOS transistor MN21 are located is turned on, to generate a pull-down starting current IDN0. The fifth NMOS transistor MN21 and the sixth NMOS transistor MN22 form a proportional mirror current source. Therefore, a pull-down current flowing through the sixth NMOS transistor MN22 is k*IDN0 (where k is a proportionality coefficient). At this time, a series branch where the sixth NMOS transistor MN22 and the fourth PMOS transistor MP21 are located is turned on, leading to a reduction of the gate voltage of the fourth PMOS transistor MP21, the gate voltage of the seventh PMOS transistor MP23, the gate voltage of the eighth PMOS transistor MP24, and the gate voltage of the ninth PMOS transistor MP25 from the power supply voltage VDD until a threshold voltage of the seventh PMOS transistor MP23, a threshold voltage of the eighth PMOS transistor MP24, and a threshold voltage of the ninth PMOS transistor MP25 are reached, so that the seventh PMOS transistor MP23, the eighth PMOS transistor MP24, and the ninth PMOS transistor MP25 are turned on, and a starting current flowing through the eighth PMOS transistor MP24 is k*IDN0 (equivalent to the sixth NMOS transistor MN22 being injected into the eighth PMOS transistor MP24). Because the fourth PMOS transistor MP21, the seventh PMOS transistor MP23, the eighth PMOS transistor MP24, and the ninth PMOS transistor MP25 together form a PMOS proportional mirror current source, a current in the seventh PMOS transistor MP23 and a current in the ninth PMOS transistor MP25 are ID23=ID25=k*IDN0, and a current in the fourth PMOS transistor MP21 is ID21=k2*IDN0 (where k2 is a proportionality coefficient). It may be learned from the foregoing analysis that to speed up the formation of an output voltage of the reference circuit, the starting current IDN0 needs to be increased, to enable the current in the reference core module 202 to reach a designed current value more quickly. However, the starting current IDN0 is nonlinear, and increasing the output current of the fifth PMOS transistor MP22 can cause a large overshoot of the reference voltage Vref outputted by the reference core module 202. In addition, a larger starting current injected by the sixth NMOS transistor MN22 into the eighth PMOS transistor MP24 indicates a higher overshoot-voltage generated instantaneously by the sampling voltage V_monitor.

As shown in FIG. 1, in a case that the adaptive overshoot-voltage suppression circuit 100 detects an overshoot-voltage generated instantaneously by the sampling voltage V_monitor when the enable EN jumps from the ground voltage VSS to the power supply voltage VDD, a high-frequency signal of the sampling voltage V_monitor is coupled to the drain end of the first NMOS transistor MN1 via using the capacitor C1. At this time, if the sampling voltage V_monitor inputted to the gate of the first NMOS transistor MN1 is greater than a threshold voltage VTHN1 of the first NMOS transistor MN1, and a difference between the sampling voltage V_monitor and the drain voltage of the first NMOS transistor MN1 is less than the threshold voltage VTHN1 of the first NMOS transistor MN1, the first NMOS transistor MN1 is in a saturation region. At this time, the first NMOS transistor MN1 has a high gain A=gm1*ro1 (where gm1 is transconductance of the first NMOS transistor MN1, and rol is output impedance of the first NMOS transistor MN1) and a miller effect, so that an equivalent capacitance of the capacitor C1 at the gate of the first NMOS transistor MN1 is increased by A times. Therefore, the overshoot-voltage of the sampled sampling voltage V_monitor increases an equivalent load capacitance at the sampling point (corresponding to the sampling voltage V_monitor) of the reference core module 202 by A times, thereby reducing the overshoot-voltage during a starting process of the reference circuit. In addition, during the process, because voltages at two ends of the capacitor C1 cannot change suddenly, a drain voltage VD1 of the first NMOS transistor MN1 increases to the sampling voltage V_monitor, and as the drain voltage VD1 of the first NMOS transistor MN1 increases, a gate voltage of the third NMOS transistor MN3 increases. After a threshold voltage of the third NMOS transistor MN3 is reached, the third NMOS transistor MN3 is turned on. The third NMOS transistor MN3 and the first resistor R1 form a common-source amplifier (where the first resistor R1 is configured for preventing the current in the third NMOS transistor MN3 from increasing too fast as the drain voltage VD1 of the first NMOS transistor MN1 increases). The drain voltage VD1 of the first NMOS transistor MN1 is converted into a current, and the current flows into the first PMOS transistor MP1, as shown in formula (1).

$${I}_{M P 1} = α \cdot [ ( VD 1 - {V}_{T H 3} ) + \frac{1}{β} ] / {R}_{1}^{2}$$

In the foregoing formula, I_{MP1} represents the current in the first PMOS transistor MP1, α represents a proportionality coefficient, and V_{TH3} represents a threshold voltage of the third NMOS transistor MN3,

$$β = {μ}_{n} {C}_{ox} \frac{W}{L} ,$$

μₙ represents a channel mobility of carriers, Cₒₓ represents a gate oxide layer capacitance per unit area, and W/L represents a width-to-length ratio of the third NMOS transistor MN3.

Because the first PMOS transistor MP1 and the second PMOS transistor MP2 form a proportional mirror current source, a current in the second PMOS transistor MP2 is IDP2=k3*IMP1. The current is a pull-up current, and is injected from a regulating point V_fb on the starting module 201 and superimposed with a current in the sixth NMOS transistor MN22. Because the current in the sixth NMOS transistor MN22 is equal to a sum of the current in the second PMOS transistor MP2 and the starting current injected into the eighth PMOS transistor MP24, the current in the sixth NMOS transistor MN22 remains unchanged. Because the current in the second PMOS transistor MP2 reflects that voltage of the sampling voltage V_monitor overshoots, when the voltage of the sampling voltage V_monitor overshoots, the current in the second PMOS transistor MP2 increases correspondingly, to reduce the starting current injected by the sixth NMOS transistor MN22 into the eighth PMOS transistor MP24, thereby suppressing the overshoot of the reference voltage outputted by the reference circuit.

FIG. 4 shows a change of the starting current injected by the sixth NMOS transistor MN22 into the eighth PMOS transistor MP24. In FIG. 4, I_{S0} so represents a starting current injected by the sixth NMOS transistor MN22 into the eighth PMOS transistor MP24 when the adaptive overshoot-voltage suppression circuit 100 is not used in the starting process of the reference circuit, and I s represents a starting current injected by the sixth NMOS transistor MN22 into the eighth PMOS transistor MP24 when the adaptive overshoot-voltage suppression circuit 100 is used in the starting process of the reference circuit. It is not difficult to find that the use of the adaptive overshoot-voltage suppression circuit 100 can reduce the starting current injected by the sixth NMOS transistor MN22 into the eighth PMOS transistor MP24.

After the overshoot of the reference voltage outputted by the reference circuit is suppressed, when the current in the seventh PMOS transistor MP23 and the current in the eighth PMOS transistor MP24 reach a designed steady-state current value IB, a voltage generated on the second resistor R21 and the fourth NMOS transistor MN20 by the current ID21 in the fourth PMOS transistor MP21 is the gate voltage Vs=k2*IB* (R21+Rds20) of the fifth PMOS transistor MP22, where Rds20 is an ON resistance of the fourth NMOS transistor MN20. When a difference between the power supply voltage VDD and the gate voltage Vs of the fifth PMOS transistor MP22 is less than a threshold voltage VTHP of the fifth PMOS transistor MP22, the fifth PMOS transistor MP22 is in an OFF state, so that the current in the fifth NMOS transistor MN21 and the current in the sixth NMOS transistor MN22 are zero, and the sixth NMOS transistor MN22 is in an OFF state and does not inject the starting current into the eighth PMOS transistor MP24. A current in the eighth PMOS transistor MP24 is only provided by a loop formed by the seventh PMOS transistor MP23, the eighth PMOS transistor MP24, the seventh NMOS transistor MN23, and the eighth NMOS transistor MN24 of the reference core module 202, so that the reference circuit starts normally to output a stable reference voltage Vref.

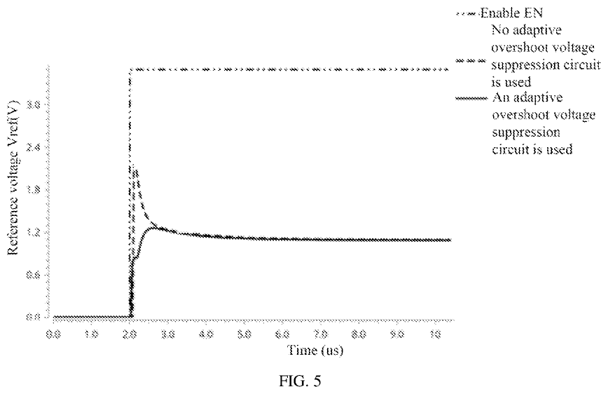

FIG. 5 shows a simulated waveform of a reference voltage Vref outputted in a starting process of a reference circuit at a normal temperature and a normal pressure. It is not difficult to find that an adaptive overshoot-voltage suppression circuit 100 can effectively suppress overshoot of the reference voltage Vref outputted by the reference circuit.

It should be emphasized that the adaptive overshoot-voltage suppression circuit provided in the present invention can also be used in a related fast-starting circuit to measure a voltage in real time, and quickly response to and effectively suppress the overshoot of the voltage. Details are not described herein.

In addition, the adaptive overshoot-voltage suppression circuit provided in embodiments of the present invention may be used in an integrated circuit chip. For a specific structure of the power supply suppression circuit in the integrated circuit chip, details are not described herein again.

The foregoing adaptive overshoot-voltage suppression circuit may also be used in a communication terminal as an important component of a radio frequency integrated circuit. The communication terminal refers to a computer device that may be used in a mobile environment and support a plurality of communication standards, such as GSM, EDGE, TD_SCDMA, TDD_LTE, and FDD_LTE, including a mobile phone, a notebook computer, a tablet computer, a vehicle-mounted computer, and the like. In addition, the technical solutions provided in the present invention are also applicable to other scenarios in which a radio frequency integrated circuit is used, such as a communication base station.

According to the adaptive overshoot-voltage suppression circuit, the reference circuit, the chip, and the communication terminal provided in the present invention, in a starting process of a to-be-measured reference circuit, a transient high-frequency inducted voltage is generated based on a sampling voltage outputted by the to-be-measured reference circuit and measured in real time, and is converted into a corresponding pull-up current. The pull-up current is injected into the to-be-measured reference circuit, and is superposed with a pull-down starting current of the to-be-measured reference circuit, to reduce a nonlinear starting current at a starting moment of the to-be-measured reference circuit, so as to quickly response to and effectively suppress the overshoot of a reference voltage outputted by the reference circuit while ensuring to a certain extent that the reference circuit meets a timing requirement.

The adaptive overshoot-voltage suppression circuit, the reference circuit, the chip, and the communication terminal provided in the present invention are described above in detail. For a person skilled in the art, any apparent modifications made to the present invention without departing from the essence of the present invention fall within the protection scope of the patent rights of the present invention.

1. An adaptive overshoot-voltage suppression circuit, comprising an overshoot-voltage suppression unit and a voltage-to-current conversion unit, wherein an input end of the overshoot-voltage suppression unit is connected to a preset sampling point on a to-be-measured reference circuit, an output end of the overshoot-voltage suppression unit is connected to an input end of the voltage-to-current conversion unit, and an output end of the voltage-to-current conversion unit is connected to a preset regulating point on the to-be-measured reference circuit; and
in a starting process of the to-be-measured reference circuit, the overshoot-voltage suppression unit generates a transient high-frequency inducted voltage based on a sampling voltage obtained from the to-be-measured reference circuit, the transient high-frequency inducted voltage is converted into a corresponding pull-up current through the voltage-to-current conversion unit, and the pull-up current is injected into the to-be-measured reference circuit, and is superposed with a pull-down starting current of the to-be-measured reference circuit, to reduce a nonlinear starting current at a starting moment of the to-be-measured reference circuit.

2. The adaptive overshoot-voltage suppression circuit according to claim 1, wherein
the overshoot-voltage suppression unit comprises a capacitor, a first NMOS transistor, and a second NMOS transistor, an end of the capacitor is connected to the sampling point and a gate of the first NMOS transistor, the other end of the capacitor is connected to a drain of the first NMOS transistor and a drain of the second NMOS transistor, a gate of the second NMOS transistor is connected to an external enable circuit, and a source of the first NMOS transistor and a source of the second NMOS transistor are connected to a common ground end voltage.

3. The adaptive overshoot-voltage suppression circuit according to claim 2, wherein
the voltage-to-current conversion unit comprises a third NMOS transistor, a first resistor, a first PMOS transistor, and a second PMOS transistor, a gate of the third NMOS transistor is connected to the drain of the first NMOS transistor, the drain of the second NMOS transistor, and the other end of the capacitor, a source of the third NMOS transistor is connected to an end of the first resistor, a drain of the third NMOS transistor is connected to a drain and gate of the first PMOS transistor and a gate of the second PMOS transistor, a drain of the second PMOS transistor is connected to the regulating point, a source of the first PMOS transistor and a source of the second PMOS transistor are connected to a power supply voltage, and the other end of the first resistor is connected to the common ground end voltage.

4. A reference circuit, comprising a starting module, a reference core module, and the adaptive overshoot-voltage suppression circuit according to claim 1, wherein an input end of the adaptive overshoot-voltage suppression circuit is connected to a preset sampling point on the reference core module, and an output end of the adaptive overshoot-voltage suppression circuit is connected to a preset regulating point on the starting module.

5. The reference circuit according to claim 4, wherein
the regulating point is a position where the starting module outputs a starting current to the reference core module.

6. The reference circuit according to claim 4, wherein
the sampling point is a position where a gate of a first NMOS transistor is turned on by a sampling voltage sampled from the reference core module.

7. An integrated circuit chip, comprising the reference circuit according to claim 4.

8. A communication terminal, comprising the reference circuit according to claim 4.
